(19) United States
(12) Patent Application Publication
(10) Pub. No.: US 2009/0052724 A1
(43) Pub. Date: Feb. 26, 2009

(54) LOUDSPEAKER

(75) Inventor: Kazuyoshi Umemura, Mie (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka, JP (JP)

(21) Appl. No.: 11/908,553

(22) PCT Filed: Feb. 5, 2007
(86) PCT No.: PCT/JP2007/051911

§ 371 Date: Sep. 13, 2007

(30) Foreign Application Priority Data
Feb. 9, 2006 (JP) 2006-032236

(51) Int. Cl. H04R 9/02; H04R 9/06

(52) U.S. Cl. 381/398; 381/400; 381/413

(57) ABSTRACT

A magnetic circuit part of a loudspeaker is formed of a plate, a magnet, and a yoke. A step is disposed in the plate that comes into contact with a disc-like magnet and forms a magnetic gap. A loudspeaker is provided where the step moves a voice coil away from the leakage magnetic field of the yoke, the influence of the leakage magnetic field is eliminated even when the output is large, the distortion is small, and the sound quality is high.

### TECHNICAL FIELD

The present invention relates to an audio loudspeaker.

### BACKGROUND ART

FIG. 5 is a half sectional view of one example of the conventional loudspeaker. This loudspeaker is substantially axially symmetric with respect to the dashed line C-C, namely the center line. In FIG. 5, a closed loop of a direct-current magnetic circuit is formed of disk-like plate 1 made of silver, disk-like magnet 2 one-size smaller than plate 1, iron-made yoke 3, and a narrow clearance (magnetic gap G) between plate 1 and yoke 3. Voice coil 4 is disposed in magnetic gap G, and can move vertically on the drawing. Voice coil 4 is coupled to the inner peripheral end of diaphragm 6 via cylindrical voice coil body 5. Diaphragm 6 vibrates to produce a sound. The outer peripheral end of diaphragm 6 is coupled to frame 8 via flexible edge 7. The back surface of diaphragm 6 is coupled to frame 8 via suspension holder 9 and flexible edge 10.

The loudspeaker of FIG. 5, among conventional loudspeakers, has relatively high sound quality. In this loudspeaker, edge 7 and edge 10 project in the opposite directions to each other, so that symmetric characteristics of the vertical amplitude of diaphragm 6 is improved, and this symmetric characteristics reduces sound distortion in the loudspeaker. Since the sound distortion can be reduced, large current can be applied to voice coil 4, and louder voice can be output.

An example of the conventional art document information related to the invention of this application is Patent document 1.

When a large current is applied to voice coil 4 in order to output louder voice, however, sound distortion due to the structural reason of the closed loop magnetic circuit becomes a problem. This sound distortion has not caused a problem before. This phenomenon is described hereinafter.

FIG. 6 is an enlarged side view of the proximity of magnetic gap G. Magnetic gap G refers to a part where plate 1 is closest to yoke 3. In magnetic gap G, magnetic flux F flows from plate 1 toward yoke 3. The vertical center position of the magnetic flux F part is generally set as the center position of the vertical movement of voice coil 4, voice coil 4 is movable vertically from the center position of the vertical movement. When a large current is applied to voice coil 4 in order to output louder voice, however, the lower end of voice coil 4 moves with a large amplitude downwardly below the bonded surface between magnet 2 and yoke 3 of FIG. 6. On the bonded surface between magnet 2 and yoke 3, however, leakage magnetic flux L returning from a right midway part of yoke 3 to the lower surface of magnet 2 exists. Leakage magnetic flux L flows in the opposite direction to magnetic flux F. When voice coil 4 comes down and enters leakage magnetic flux L, voice coil 4 receives an upward force in the opposite direction to the force from magnetic flux F. When the upward force enlarges the amplitude of voice coil 4, the symmetric characteristics of the amplitude degrades to cause the sound distortion, disadvantageously.

[Patent document 1] Japanese Patent Unexamined Publication No. 2004-7332

### SUMMARY OF THE INVENTION

The loudspeaker of the present invention has a disc-like magnet, a plate in contact with one surface of the magnet, and a yoke that is in contact with the surface of the magnet on the opposite side to the plate and extends to the proximity of a side surface of the plate to form a magnetic gap. The side surface of the plate has a part that has a diameter substantially the same as that of the magnet and is formed on the contact side with the magnet, and a part that has a diameter larger than that of the magnet and projects to form a magnetic gap. The present invention can provide a loudspeaker that causes only small sound distortion even when the output is large.

### BRIEF DESCRIPTION OF DRAWINGS

FIG. 1 is a half sectional view of a loudspeaker in accordance with a first exemplary embodiment of the present invention.

FIG. 2 is an enlarged view of an essential part of FIG. 1.

FIG. 3 is an enlarged view of a magnetic circuit part of FIG. 1.

FIG. 4 is a sectional view of a loudspeaker in accordance with a second exemplary embodiment of the present invention.

FIG. 5 is a sectional view of a conventional loudspeaker.

FIG. 6 is an enlarged view of a magnetic gap part of FIG. 5.

### REFERENCE MARKS IN THE DRAWINGS

21 plate

2 magnet

3 yoke

4 voice coil

5 voice coil body

6 diaphragm

7 first edge

8 frame

10 second edge

13 third edge

a equal-diameter sectional part

b projecting part

F magnetic flux

L leakage magnetic flux

### DETAILED DESCRIPTION OF PREFERRED EMBODIMENTS

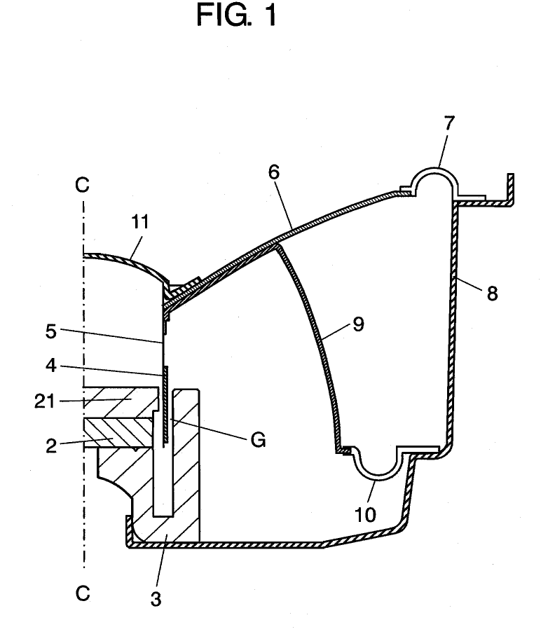

Exemplary embodiments of the present invention will be described hereinafter with reference to FIG. 1 through FIG. 4. Each of FIG. 1 through FIG. 4 is a schematic diagram, and does not show the dimension at an accurate contraction scale.

### First Exemplary Embodiment

FIG. 1 is a sectional view showing the right half formed by cutting a loudspeaker of the present invention on the front side. This loudspeaker is substantially axially symmetric with respect to the dashed line C-C, namely the center line. In FIG. 1, a closed loop of a direct-current magnetic circuit is formed of iron-made plate 21, disk-like magnet 2, iron-made yoke 3, and a narrow gap (magnetic gap G) between plate 21 and yoke 3. Voice coil 4 is disposed in magnetic gap G, and can move vertically on the drawing. Voice coil 4 is coupled to the inner peripheral end of diaphragm 6 via cylindrical voice coil body 5. Diaphragm 6 vibrates to produce a sound. The outer peripheral end of diaphragm 6 is coupled to frame 8 via first flexible edge 7. The back surface of diaphragm 6 is coupled to frame 8 via suspension holder 9 and flexible edge 10. Voice coil body 5 has a structure where voice coil 4 is wound on the outer periphery of the cylindrical body, and is arranged so as to vertically move in magnetic gap G. Thus, thin-pan-like diaphragm 6 coupled to the outer periphery of the upper part of voice coil body 5 is vibrated. The upper end of voice coil body 5 has dust cap 11 for measures against dust.

Diaphragm 6 works as a sound producing source of the loudspeaker, and is mainly made of pulp and resin having high rigidity and large internal loss. The outer peripheral end of diaphragm 6 is coupled to the opening end of frame 8 via upwardly projecting first edge 7, and the inner peripheral end is fixed to the outer peripheral side of voice coil body 5 with an adhesive (not shown). First edge 7 is made of urethane, expanded rubber, styrene butadiene rubber (SBR), or cloth not to apply a large dynamical load to diaphragm 6.

Suspension holder 9 has a circular truncated cone shape as a whole. As shown in FIG. 1, the inner periphery (upper surface flange part) of suspension holder 9 is stuck and fixed to the lower surface side of diaphragm 6 with an adhesive. The inner peripheral end surface inside the inner periphery is fixed to the outer periphery of voice coil body 5 with an adhesive. The outer peripheral end of suspension holder 9 is coupled to frame 8 via second edge 10. Second edge 10 projects in the opposite direction to first edge 7 in the present embodiment.

In this structure, when a voice signal is supplied to voice coil 4, the voice signal reacts with the magnetic field in magnetic gap G to move voice coil body 5 vertically. This movement vibrates diaphragm 6 to transmit a sound from the loudspeaker. Especially, in the present embodiment, since diaphragm 6 is supported also by suspension holder 9, the outer peripheral end of suspension holder 9 is coupled to frame 8 via second edge 10, and the projecting direction of second edge 10 is opposite to that of edge 7, the vertical amplitude of diaphragm 6 can be made substantially symmetric in the vertical direction. Therefore, the sound distortion in the loudspeaker is significantly reduced.

For details, both edge 7 and edge 10 are apt to deform in the projecting direction, but hardly deform in the opposite direction. Since edge 7 and edge 10 project in the opposite directions to each other and are symmetric, deforming ease in the vertical direction of edge 7 is substantially the same as that of edge 10. Thus, the vertical amplitude of diaphragm 6 can be made substantially symmetric in the vertical direction, and hence the sound distortion in the loudspeaker can be reduced. Therefore, even when a large current is applied to voice coil 4, voice louder than before can be output without sound distortion.

When a large current is applied to voice coil 4 in order to output further louder voice, however, loudspeaker distortion due to the structural reason of the magnetic circuit occurs similarly to description of the conventional example.

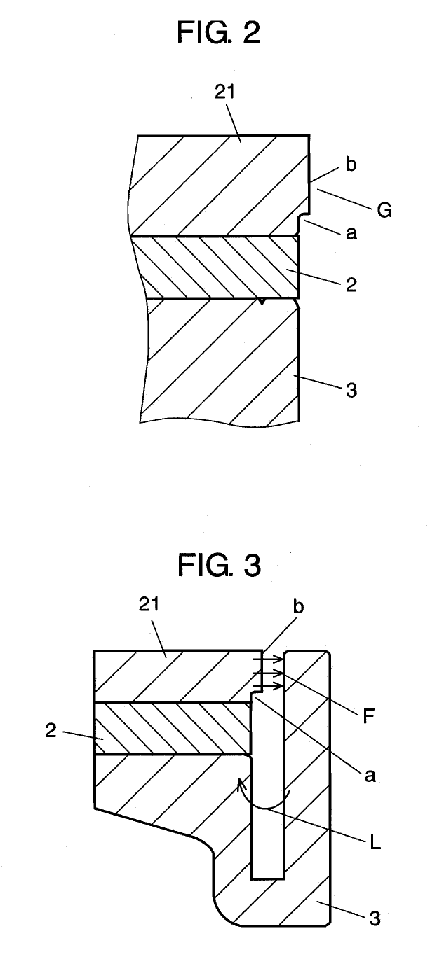

In the present embodiment, the side surface of disk-like plate 21 constituting the direct-current magnetic circuit has a new shape. FIG. 2 is an enlarged sectional view of an essential part of FIG. 1. As shown in FIG. 2, the cross section of plate 21 is formed of equal-diameter sectional part (a) having a diameter substantially equal to that of magnet 2 and projecting part (b) having a cross section with a diameter larger than that of magnet 2. Projecting part (b) is very close to yoke 3, so that magnetic flux F mainly concentrates in projecting part (b), and magnetic flux hardly occurs between equal-diameter sectional part (a) and yoke 3. In other words, plate 1 of the conventional example is thickened by thickness corresponding to equal-diameter sectional part (a), and hence magnetic gap G is moved up higher than that of the conventional example (to the diaphragm 6 side). The vertical center of voice coil 4 is matched with the vertical center of magnetic gap G, and voice coil 4 is moved vertically from the latter center.

In the case where the vertical center of voice coil 4 is set higher than that in the conventional example, even when a large input is applied to voice coil 4 to largely vibrate it vertically, the lower end of voice coil 4 hardly moves down below the bonded point between magnet 2 and yoke 3. If the lower end moves down below it, the moving distance is short. As a result, the symmetric characteristics of vertical amplitude is hardly damaged, so that a loudspeaker distortion problem hardly arises in the loudspeaker.

FIG. 3 is an enlarged view of the magnetic circuit part. The magnetic circuit part is further described in detail. On the bonded surface between magnet 2 and yoke 3, however, leakage magnetic flux L returning from a right midway part of yoke 3 to the lower surface of magnet 2 exists. Leakage magnetic flux L flows in the opposite direction to magnetic flux F that flows from plate 21 toward yoke 3 in magnetic gap G. When the lower end of voice coil 4 having received a downward force from magnetic flux F comes down and enters leakage magnetic flux L of the opposite direction to magnetic flux F, voice coil 4 receives an upward force reversely, thereby causing the distortion. In the present embodiment, plate 21 has equal-diameter sectional part (a) and projecting part (b), and hence the magnetic gap is moved up higher than that of the conventional example (to the diaphragm 6 side). The vertical center of voice coil 4 is matched with the vertical center of the magnetic gap, and voice coil 4 is moved vertically from the latter center. In the case where the vertical center of voice coil 4 is set higher, even when a large input is applied to voice coil 4 to largely vibrate it vertically, the lower end of voice coil 4 hardly moves down below the bonded point between magnet 2 and yoke 3. If the lower end moves down below it, the moving distance is short. As a result, the loudspeaker distortion problem that is apt to arise in a loudspeaker of a large output hardly arises in the present embodiment.

Plate 21 is made of iron, for example. Equal-diameter sectional part (a) with a small cross section can be compression molding with a die from an iron plate whose whole size is equal to that of projecting part (b). When equal-diameter sectional part (a) is thus compression molding, not only the surface thereof hardens and but also carbon gathers on the surface. As a result, a magnetic flux hardly occurs from the surface of sectional part (a). Thus, the magnetic field near the magnetic gap is apt to be stable, and hence the vertical amplitude of voice coil body 5 is apt to be stable.

The materials of plate 21 and yoke 3 are not limited to iron, but any material of high magnetic permeability can be applied. When compression molding is performed partially, metal material is more preferable from the viewpoint of forming ease.

### Second Exemplary Embodiment

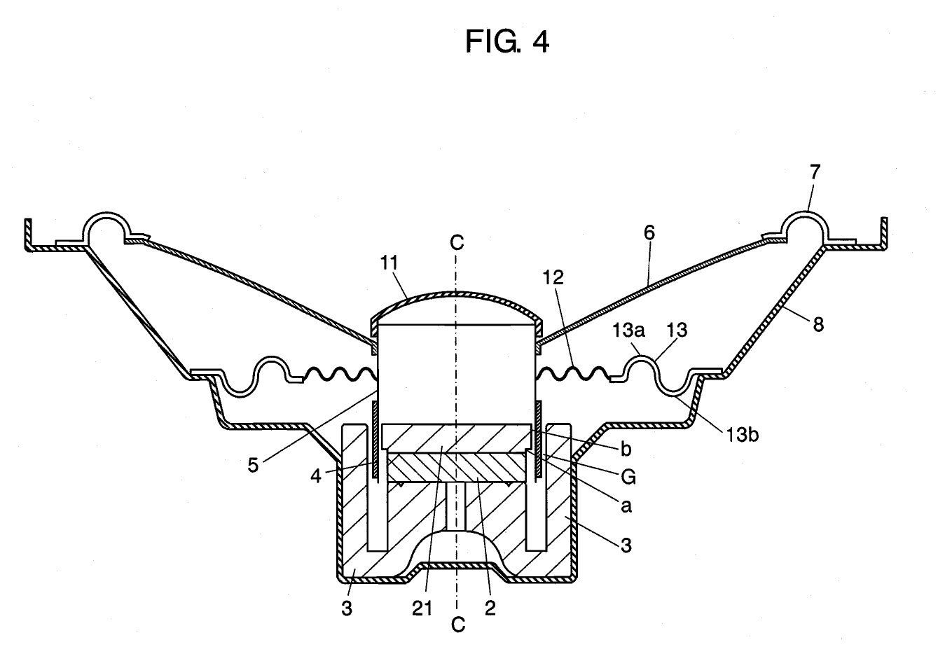

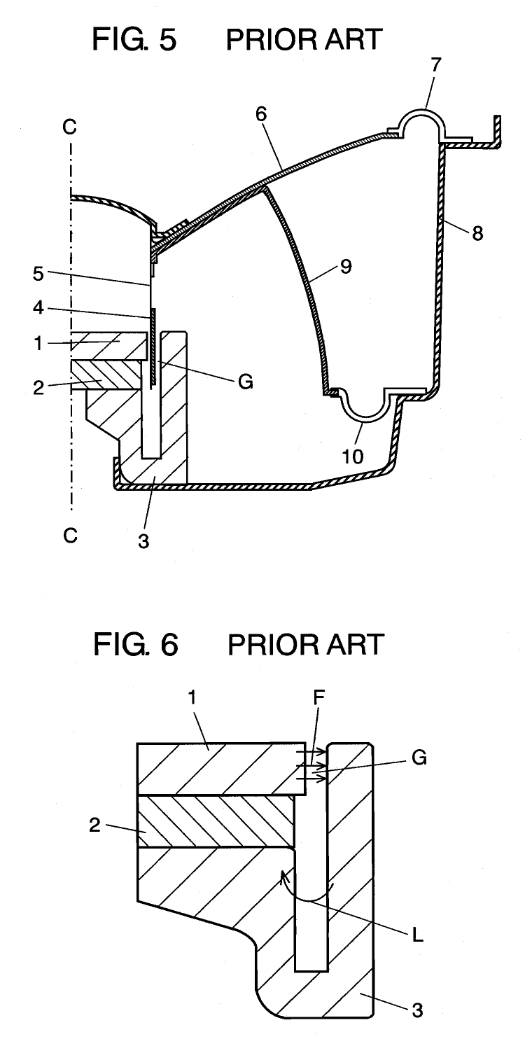

FIG. 4 is a sectional view showing a loudspeaker for high/intermediate pitched sound in accordance with a second exemplary embodiment of the present invention. The loudspeaker is substantially axially symmetric with respect to the dashed line C-C, namely the center line. The loudspeaker is formed by combining substantially disk-like plate 21, disk-like magnet 2, substantially cylindrical yoke 3 and sticking them to the center of the bottom of bowl-shaped metal frame 8, similarly to the first exemplary embodiment. Magnetic gap G is formed between the inner peripheral surface of the outer wall part of yoke 3 and the outer peripheral surface of plate 21. Voice coil body 5 has a structure where voice coil 4 is wound on the outer periphery of the cylindrical body, and is engaged with magnetic gap G so as to move vertically. This vertical movement of voice coil 4 vibrates thin-pan-like diaphragm 6 that is coupled to the outer periphery of the upper part of voice coil body 5. The upper end of voice coil body 5 has dust cap 11 for measures against dust.

Diaphragm 6 works as a sound producing source of the loudspeaker, and is mainly made of pulp and resin having high rigidity and large internal loss. The outer peripheral end of diaphragm 6 is coupled to the opening end of frame 8 via upwardly projecting flexible edge 7, and the inner peripheral end is fixed to voice coil body 5. First edge 7 is made of material such as urethane, expanded rubber, SBR, or cloth not to apply a dynamical load to diaphragm 6. The inner peripheral end of damper 12 is coupled to voice coil body 5, and the outer peripheral end thereof is coupled to frame 8 via flexible third edge 13 other than damper 12. Damper 12 has a corrugated-disc-like ring structure, and expands and contracts in response to movement of voice coil body 5. Similarly to edge 7 coupled to diaphragm 6, damper 12 is made of material such as urethane, expanded rubber, SBR, or cloth not to apply a dynamical load to diaphragm 6. When a voice signal current is applied to voice coil 4, the voice signal current reacts with the magnetic field in magnetic gap G to move voice coil body 5 vertically. This movement vibrates diaphragm 6 to transmit a sound from the loudspeaker.

Especially, in the present embodiment, disposing third edge 13 at the outer peripheral end of damper 12 suppresses the distortion of the loudspeaker, and further increases the driving efficiency of the loudspeaker. This phenomenon is described.

Conventionally, the outer/inner peripheral ends of damper 12 are coupled to frame 8 and voice coil body 5, respectively, without using third edge 13. The action of damper 12 suppresses rolling during movement of voice coil body 5, and damper 12 has a corrugated plate shape and elasticity to easily follow the movement of voice coil body 5. When the amplitude of voice coil body 5 is small, damper 12 hardly applies a large load to the movement of voice coil body 5. When the amplitude of voice coil body 5 is large, however, damper 12 applies a large load because damper 12 has the corrugated plate shape. In the present embodiment, the outer periphery of damper 12 is coupled to frame 8 via third edge 13. This structure allows voice coil body 5 to move widely, stress is applied to third edge 13 when damper 12 applies a large load, and third edge 13 elastically deforms in response to the stress. The elastic deformation reduces the stress to suppress reduction of the driving efficiency.

In the present embodiment, voice coil body 5 and diaphragm 6 are supported by edge 7, damper 12, and third edge 13. For increasing the driving efficiency of diaphragm 6 used in a loudspeaker for high/intermediate pitched sound, edge 7 is thinned to be lightened in weight, and hence the weight of diaphragm 6 and edge 7 is reduced. When edge 7 is thinned, however, the supporting strength of voice coil body 5 is reduced. Therefore, third edge 13 is correspondingly made thicker than edge 7 to prevent reduction of the supporting strength of voice coil body 5. As a result, the total modulus of elasticity of damper 12 and third edge 13 is larger (harder) than that of edge 7.

In this structure, since voice coil body 5 is mainly supported by damper 12 and third edge 13, the vertical loads of damper 12 and third edge 13 are required to be as the same as possible in order to suppress the distortion of vertical movement of diaphragm 6. In the present embodiment, third edge 13 has first projecting part 13a projecting toward the diaphragm 6 side, and second projecting part 13b projecting in the opposite direction to first projecting part 13a. Damper 12 originally has a corrugated-disc-like ring structure, and is substantially symmetric in the vertical direction, so that the vertical load of damper 12 is in substantially the same state. Therefore, in the present embodiment, the vertical load on the bonded body of damper 12 and third edge 13 is substantially symmetric, and excellent sound quality can be obtained even when the output is large. Since edge 7 is lightened in weight, the loudspeaker has high driving efficiency even when it is used for high/intermediate pitched sound.

In this structure where damper 12 is coupled to frame 8 via third edge 13, the power linearity can be secured by corrugated-plate-like damper 12 until the movable width of voice coil body 5 becomes great to some extent. When the movable width of voice coil body 5 is a predetermined value or greater and its linearity is difficult to be secured, the elasticity of third edge 13 compensates the linearity. In consideration of these functions, preferably, the elasticity of third edge 13 is set larger (harder) than that of damper 12.

The elasticity of damper 12 and third edge 13 are different from each other, and preferably are set so that damper 12 and third edge 13 independently function in response to the movable width of voice coil body 5. The modulus of elasticity of the part between damper 12 and third edge 13, specifically in a coupling region between them, is set larger (harder) than those of damper 12 and third edge 13, thereby securing independence of them.

For setting the modulus of elasticity of the coupling region between damper 12 and third edge 13 to be larger (harder) than those of damper 12 and third edge 13, the following example is effective:
a hard adhesive such as an acrylic adhesive is used as the adhesive for bonding third edge 13 to damper 12;
third edge 13 and damper 12 are unified by insert molding and the unified part is thickened; or
a reinforcing material is stuck to the coupling region.

FIG. 4 shows a loudspeaker that has edge 7 lightened in weight, is used for high/intermediate pitched sound, and has high driving efficiency in the present embodiment. The vertical amplitude of diaphragm 6 is substantially symmetric in the vertical direction, thereby reducing the distortion of the loudspeaker. The magnetic circuit in this loudspeaker has the structure of FIG. 2 similarly to the embodiment shown in FIG. 1. In other words, the end surface on the voice coil body 5 side of disk-like plate 21 constituting the magnetic circuit has equal-diameter sectional part (a) on the magnet 2 side and projecting part (b) projecting to the yoke 3 side, as shown in FIG. 2. In other words, plate 21 is thickened by thickness corresponding to equal-diameter sectional part (a), and hence magnetic gap G is moved up higher than that of the conventional example (to the diaphragm 6 side). The vertical center of voice coil 4 is matched with the vertical center of magnetic gap G, and voice coil 4 is moved vertically from the latter center. Even when a large input is applied to voice coil 4 to largely vibrate it vertically, the lower end of voice coil 4 hardly moves down below the bonded point between magnet 2 and yoke 3. If the lower end moves down below it, the moving distance is short. Therefore, even when the amplitude increases, the amplitude symmetric characteristics can be kept. As a result, a problem about loudspeaker distortion can be reduced in a low-distortion loudspeaker.

### INDUSTRIAL APPLICABILITY

The present invention allows reduction of sound quality distortion occurring when the amplitude is increased to increase the sound volume in a loudspeaker. The present invention is useful for not only a loudspeaker for low pitched sound but also a loudspeaker for high/intermediate pitched sound.

1. A loudspeaker comprising:
a disc-like magnet;
a plate in contact with one surface of the magnet;
a yoke in contact with the magnet on an opposite surface to the plate and extending to a proximity of a side surface of the plate to form a magnetic gap;
a voice coil inserted into the magnetic gap; and
a diaphragm interlocking with the voice coil,
wherein the plate includes a part that is disposed on a contact side with the magnet and has a diameter identical to that of the magnet, and a part that is disposed on a non-contact side with the magnet, has a diameter larger than that of the magnet, and faces the yoke to form a magnetic gap.

2. The loudspeaker of claim 1, further comprising:
a frame;
a first edge for supporting the diaphragm, the first edge being coupled to the frame;
a voice coil body for supporting the voice coil;
a suspension holder, an inner peripheral side of the suspension holder being fixed to one of the diaphragm and the voice coil body; and
a second edge for supporting an outer peripheral side of the suspension holder, the second edge being coupled to the frame,
wherein the first edge and the second edge project in the opposite directions to each other.

3. The loudspeaker of claim 1, further comprising:
a frame;
a voice coil body for supporting the voice coil;
a first edge for supporting the diaphragm, the first edge being coupled to the frame;
a damper for supporting the voice coil body on an inner peripheral side of the damper; and
a third edge for supporting the damper on an outer peripheral side of the third edge, the third edge being coupled to the frame.

4. The loudspeaker of claim 3,
wherein modulus of elasticity of the third edge is larger than modulus of elasticity of the damper.

5. The loudspeaker of claim 1,
wherein a surface of the plate in a part that is disposed on a contact side with the magnet and has a diameter identical to that of the magnet is a compression molding surface.

6. The loudspeaker of claim 2,
wherein a surface of the plate in a part that is disposed on a contact side with the magnet and has a diameter identical to that of the magnet is a compression molding surface.

7. The loudspeaker of claim 3,
wherein a surface of the plate in a part that is disposed on a contact side with the magnet and has a diameter identical to that of the magnet is a compression molding surface.

8. The loudspeaker of claim 4,
wherein a surface of the plate in a part that is disposed on a contact side with the magnet and has a diameter identical to that of the magnet is a compression molding surface.
